(19) United States
(12) Patent Application Publication
(10) Pub. No.: US 2009/0198505 A1
(43) Pub. Date: Aug. 6, 2009

(54) INTERACTIVE PATH PLANNING WITH DYNAMIC COSTING

(76) Inventors: Peter Gipps, Heatherton (AU); Liam T. Merlot, South Yarra (AU)

Correspondence Address: STRATEGIC PATENTS P.C.., C/O PORTFOLIOIP, P.O. BOX 52050, MINNEAPOLIS, MN, 55402, US

(21) Appl. No.: 12/025,884

(22) Filed: Feb. 5, 2008

(51) Int. Cl. G06Q 10/00

(52) U.S. Cl. 705/1

(57) ABSTRACT

An interactive path planning system supports a designer's efforts to manually optimize routes for cost, constructability, environmental considerations, and the like. This permits a user to manually seek optimizations of a route cost that are not be available through automated cost optimization algorithms and techniques. Moreover, this may permit the user to experiment with alternate route paths while being provided with cost information via the interface. The interface may provide cost calculations based upon the true route geometry that will be employed to physically construct the route, rather than a computational model employed during an interactive design process.

### BACKGROUND

Path planning for road, rail, pipelines, and the like involves planning a route between two locations within the context of a physical environment and within the context of any design rules imposed on the path such as limitations on grade and curvature. A designer also typically seeks to reduce costs by finding the cheapest available route for a particular path. Design tools have been created to allow interactive path planning, and costing tools have been created for calculating and optimizing the cost of paths. However, for a number of reasons these tasks remain largely separated.

As an organizational matter, those responsible for completing a design may be separate for those responsible for budgeting the construction of the design. As a technical matter the technical disciplines associated with interactive design interfaces as versus costing/estimating tools are different, and the associated software tools may be supplied by different vendors. Further (and in part as a result of the foregoing), the computer model used for interactive design is typically different from the computer model used for costing, and both of these models may differ from the true-geometry representation required for route construction. For example, a typical path design process begins with an alignment consisting of straight-line segments, which may be enhanced by adding curvilinear elements at transitions between straight portions. A completed alignment is then submitted to a costing tool that evaluates the cost of a design. While the alignment is a useful and computationally efficient abstraction for supporting an interactive design session, the resulting path does not reflect true route geometry used to construct a corresponding physical path. Thus, with different software and data models being employed by different users, existing workflows typically employ a phased approach in which a design is completed, and then data is extracted from the design to perform costing/optimization. Where the optimization identifies changes to a route, this information must be imported back into the design environment as a new route. As a result, it may be difficult for a user to engage in any meaningful, manual optimization of a path even where potential cost reductions are visually apparent to a skilled designer.

There remains a need for an interactive path planning system that supports a designer's efforts to manually optimize routes for cost, constructability, environmental considerations, and the like.

### SUMMARY

An interactive path planning system supports a designer's efforts to manually optimize routes for cost, constructability, environmental considerations, and the like. This permits a user to manually seek optimizations of a route cost that are not be available through automated cost optimization algorithms and techniques. Moreover, this may permit the user to experiment with alternate route paths while being provided with cost information via the interface. The interface may provide cost calculations based upon the true route geometry that will be employed to physically construct the route, rather than a computational model employed during an interactive design process.

In one aspect, a method disclosed herein includes displaying a route and a cost of constructing the route in an interactive route design interface; receiving an adjustment to the route; calculating an updated cost of the route with the adjustment; and displaying the updated cost in the interactive route design interface in substantially real time.

The step of receiving the adjustment to the route may include receiving an adjustment to an alignment that defines the route as a series of straight lines joined at one or more intersecting points. The method may add a transition curve to at least one of the one or more intersecting points to form a curvilinear path between two adjacent ones of the series of straight lines. The method may calculate the updated cost based upon the curvilinear path. The route may be one or more of a railway path and a roadway path. The route may include at least one of a printed circuit board trace path, a canal path, a subway path, a utility path, a duct path, a conveyor belt path, and a pipe path. The adjustment to the route may include one or more of a vertical adjustment and a horizontal adjustment. The method may automatically select an element of the route according to cost in response to the adjustment. The element may include one or more of a bridge, a tunnel, an earthwork, a bench, a retaining wall, and a stepped batter slope. The method may automatically adjust an element of the route according to cost in response to the adjustment. The element may include one or more of a bridge, a tunnel, earthworks, a bench, a retaining wall, and a side slope. The method may either stop the adjustment or reject the adjustment when the adjustment violates the design rule. The method may also, or instead, stop the adjustment or reject the adjustment when the adjustment violates an environmental constraint. The method may automatically revise the adjustment to conform to the design rule when the adjustment violates the design rule. The method may also, or instead, automatically revise the adjustment to conform to an environmental constraint when the adjustment violates the environmental constraint. The method may include testing the route against an environmental constraint in response to the adjustment. The environmental constraint may relate to a region of social, historical, or cultural significance. The environmental constraint may relate to a protected ecological region. The environmental constraint may prevent an incursion of the route into a region. The environmental constraint may impose remediation costs for an incursion of the route into a region.

The interactive route design interface may include a web-based interface and calculating a cost may include calculating the cost at a remote server and transmitting the cost to a client that provides the web-based interface. All of the steps of the method may be performed by a client-based application. All of the steps of the method may be performed on a stand-alone computer system.

In one aspect, a method disclosed herein includes receiving a description of a route; automatically optimizing the route according to a cost; displaying the route and the cost; receiving a manual adjustment to the description of the route; calculating an update cost of the route with the manual adjustment in substantially real time; and displaying an update cost in substantially real time.

The step of displaying the route may include rendering the route in a plan view and a profile view. The step of displaying the route may include rendering the route in a plan view and a profile view. The method may includes a step of checking the manual adjustment against one or more design rules and/or environmental constraints, and incorporating the manual adjustment into the route only when the manual adjustment conforms to the one or more design rules and/or environmental constraints.

In one aspect, a method disclosed herein includes displaying a three-dimensional model of a terrain; receiving a route description including a series of straight elements joined by a plurality of intersection points within the three-dimensional model; automatically inserting one or more curves that conform to a design standard and/or environmental constraint at each one of the plurality of intersection points; automatically inserting one or more elements along the route, the one or more elements including at least one of a bridge, a tunnel, a retaining wall, and a stepped batter slope, and each one of the one or more elements elected according to a cost of the element as constructed in the terrain; calculating a cost of the route, including the one or more curves and the one or more elements in substantially real time; and displaying the cost.

The one or more curves may include at least one of a circular segment and a spiral segment. The method may display the route description on the three-dimensional model. The method may display the route description in one or more of a plan view and a profile view.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 shows a high-level architectural drawing of an interactive path planning system.

FIG. 2 shows an abstract depiction of a data structure that may be used with an interactive path planning system.

FIG. 3 shows a flow chart of a process for interactive path planning.

FIG. 4 shows a flow chart of a process for interactive path planning.

FIG. 5 shows a user interface for an interactive path planning system.

FIG. 6 shows a user interface for an interactive path planning system.

FIG. 7 shows a user interface for interactive path planning.

### DETAILED DESCRIPTION

The following description sets out numerous embodiments of an interactive path planning system that provides substantially real time cost updates during an interactive design session. However, it will be understood that the principles of the invention have broad application, and may be employed in numerous other contexts where cost information provides useful feedback to a designer. For example, the principles of the invention may be usefully applied by an architect to plan utilities paths within a building, or by a circuit designer to find cost-optimized routing for wire traces on a semiconductor device or printed circuit board. All such variations are intended to fall within the scope of this disclosure.

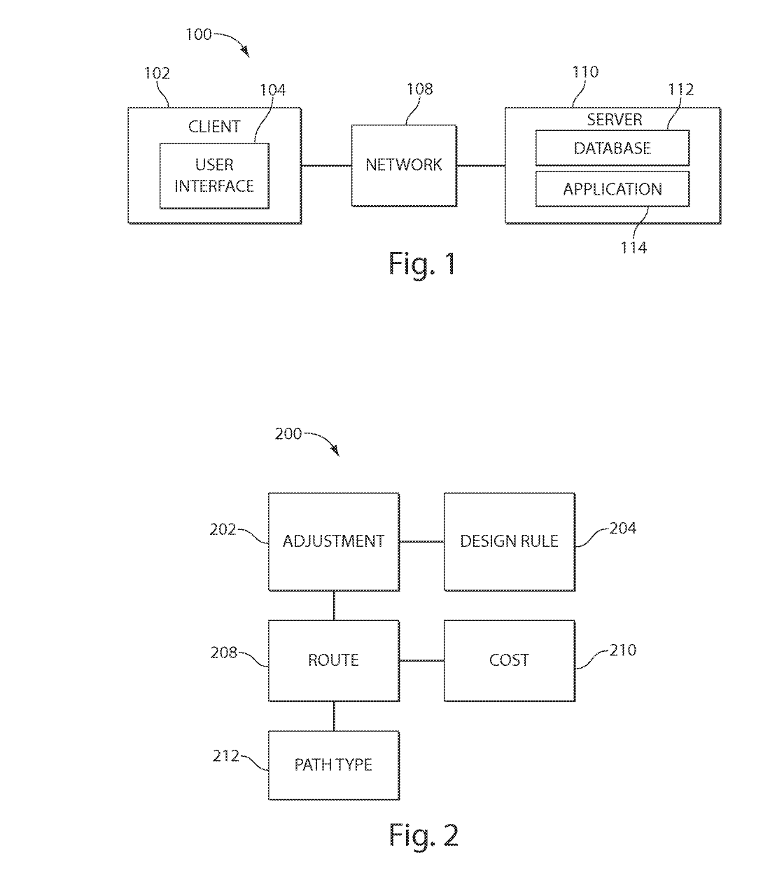

FIG. 1 shows a high-level architectural drawing of an interactive path planning system. The system 100 may include a client 102 with a user interface 104, a network 108, and a server 110 with a database 112 and a server-side application 114.

The client 102 may be any computer device and associated software suitable for use with the systems and methods described herein, such as and without limitation a desktop computer, a laptop computer, or the like. The client 102 may be connected to the network 108 via an Ethernet connection, a WiFi connection, or any other suitable network connection, or a combination of these. In general, the client 102 may display the user interface 104 along with any content therein, and may accept user inputs that relate to the user interface 104. It will be understood that a wide variety of computing devices may be employed as the client 102.

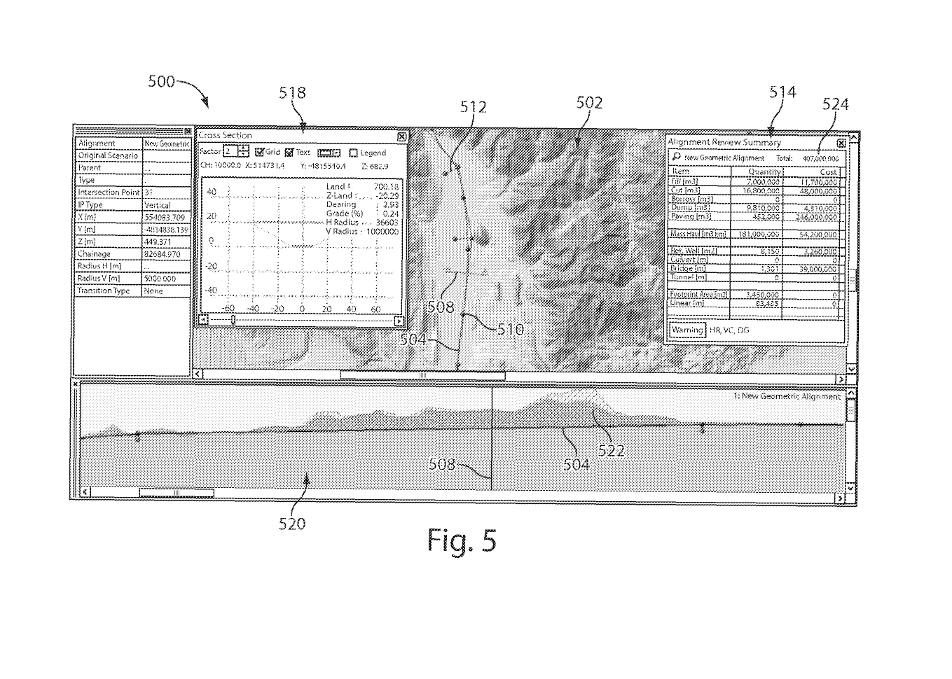

The user interface 104 may be graphical in nature and may be displayed via a monitor, projector or other display of the client 102. In general, the user interface 104 may contain any information or controls for use with the systems and methods described herein. For example, information in the interface 104 may include a variety of content such as topographical maps, satellite photos, or other maps or context for route planning, along with other useful information such as elevation profiles, routes, route elements, route cost, and the like. Controls within the interface 104 may include any number of controls for receiving user input such as navigation tools (e.g., pan, zoom, tilt, etc.), text input tools, annotation tools, file management tools and so forth. This may also include tools for placement and manipulation of path elements such as bridges, tunnels, embankments, earthworks, intersections, freeway interchanges, and the like, as well as tools for placing and connecting points along the path. The user interface 104 may display information relating to a route and its cost. As described in greater detail below, the user interface 104 may receive changes in the path, and may update cost information in response. Such cost updates may be substantially in real time, i.e., with little or no observable latency between the modifications to the path and the display of cost information. While phrases such as “substantially real time” and the like as used herein may refer to conventional real time rates such as a display refresh rate or a video rate, other cost update rates may also usefully serve the purposes described herein (such as providing feedback to a designer concerning the cost of path modifications), and may be considered substantially real time within the scope of this disclosure. For example, a delay of a fraction of a second or even a full second or a few seconds may be sufficiently real time to permit a designer to usefully iterate over a number of design variations and obtain cost information during an interactive design session using the user interface. Upon receiving a user path modification, the user interface 104 may display an update to both the route and the cost. The path and cost information may also or instead be updated in response to automatic route adjustments, optimizations, or other computer-generated path modification. Embodiments of the user interface 104 are described in greater detail with reference to FIGS. 5-7 below.

The network 108 may be any network suitable for connecting the client 104 and the server 110 in a communicating relationship. This may include, for example, any number of local area networks, metropolitan area networks, wide area networks, wireless networks, satellite networks, and the like as well as the Internet and any other private or public network, and combinations of the foregoing, provided the network can support data communications between the client 102 and the server 110. It will be understood that the network 108 may employ a wide variety of networking protocols and technologies, all of which are known to one of ordinary skill in the art.

The server 110 may be a computer, such as and without limitation a rack-mount computer, a blade computer, a desktop computer or the like. In general, the server 110 responds to requests from the client 102, and may support any of a variety of interactions between the client 102, the server 110, and other resources on the network 108. The server 110 may, for example, provide or support the application 114 and the database 112 of the system. The server 110 may be connected to the network 108 via an Ethernet connection or any other suitable network connection. It will be understood that a server may be implemented on any number of computers, or as one of a number of servers on a single computer, and that a variety of server architectures may be employed consistent with the operations described herein.

The database 112 may include a database management system, a flat file system, or any other data storage system suitable for storing data described herein. It will be appreciated that a wide variety of schemas and storage strategies are known and may be employed with the systems and methods described herein. An abstract representation of content that may be stored in the database 112 is described below with reference to FIG. 2.

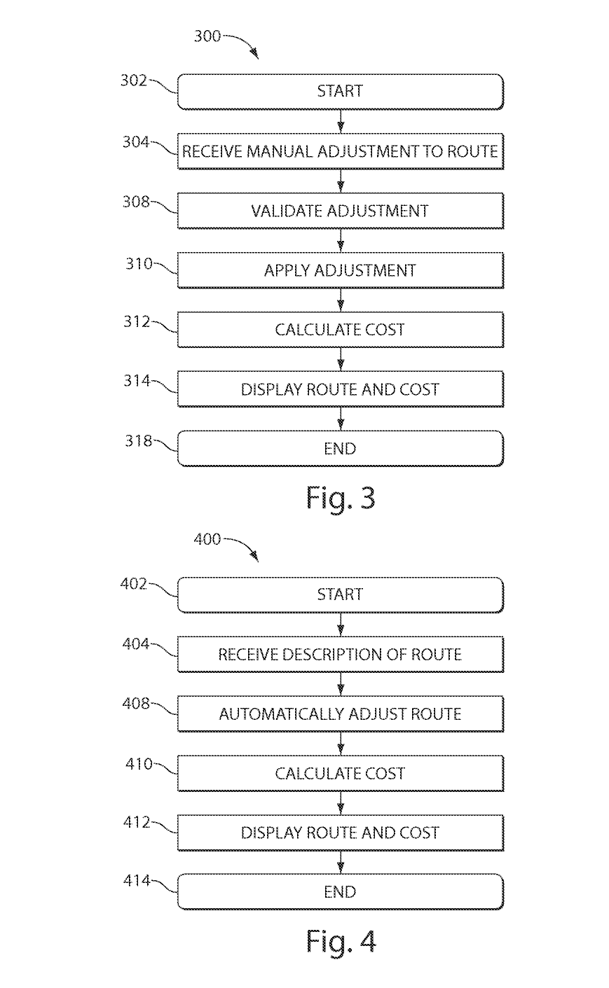

The application 114 may communicate with the client 102 via the network 108; maintain a representation of terrain and a route; perform calculations related to adjusting or validating the route; and so on. Examples of operation of the application are described in greater detail below with reference to FIGS. 3 and 4. It will be understood that the application 114 may be implemented in any suitable programming language and according to any suitable programming methodologies, architectures, and the like. The application 114 may, for example, execute on the client 102, on the server 110, or some combination of these.

In general, communications between the client 102 and the server 110 may be any information relating to the operation of the system 100, such as a transfer of information relating to inputs received through the user interface 104, a transfer of results of a calculation performed by the application 114, and so on. Communications received at the client 102 may include cost information, route information, maps, aerial photograph data, or any and all other information supporting the interactive path planning system. Communications received at the server 110 may include route adjustment information, user-initiated file operations, or the like. It will be understood that the information communicated between the client 102 and server 110 may be encoded in binary data, a web page, an XML file, a marshaled or serialized data object, or any other form. It will be appreciated that the embodiments described herein are examples only and that more generally, communications relating to the functions and operations of an interactive path planning system may be distributed in a variety of ways among a client device and one or more servers, or the entire system may be implemented on a single, stand-alone computing device. All such variations are intended to fall within the scope of this disclosure.

FIG. 2 shows an abstract depiction of a data structure that may be used with an interactive path planning system. The data structure 200 may include, for example, an adjustment 202 to a route, a design rule 204, a route 208, a cost 210, and a path type 212.

The route 208 generally characterizes a path of a roadway, railway, canal, subway, utilities, pipes, and the like or combination of these through an environment such as a terrain. The route 208 may include a collection of linear and curvilinear segments in at least two dimensions. Additionally, the route 208 may include intersecting points where various paths intersect or align with one another. The route 208 may also include any number of elements that describe portions of the path. For example and without limitation, a route 208 that represents a roadway may include earthworks, bridges, tunnels, retaining walls, side slopes, and other elements used to construct a roadway on a terrain. It will be understood that a wide variety of such elements may be employed with the route 208.

The cost 210 may be an estimated cost for constructing the route 208. The cost 210 may be calculated by the application 114 and displayed within the user interface 104 substantially in real time.

The path type 212 may encode the kind of path that the route 208 represents. The path type 212 may be roadway, railway, canal, subway, conductive trace, wiring, duct pipe, and so on. The path type 212 may also encode elements of the route, such as any of the elements described above, which may be portions of the route 208 (e.g., paved road, rail tracks, etc.) and/or associated elements (e.g., embankments, bridges, etc.). It will be understood that a wide variety of path types 212 may be employed. It will also be understood that the abstract description herein is intended to provide an example and not to limit the wide variety of possible ways to represent routes and elements thereof in a path planning system. For example, individual elements may be encoded as segments of a route, or as data correlated in any of a variety of ways with locations or spans along the route. Similarly, costs may be represented as costs associated with various route elements, and calculated dynamically, or the costs may be stored as actual costs of actual elements within a particular route 208. All such variations as would be apparent to one of ordinary skill in the art are intended to fall within the scope of this disclosure.

The adjustment 202 to a route 208 may be an adjustment to any and all segments or elements of the route 208. The adjustment 202 may be received from a user via the user interface 104, encoded, and then communicated to the application 114, which processes the adjustment 202. Alternatively or additionally, the adjustment 202 may be automatically generated. It should be appreciated that the path type 212 and the adjustments 202 may be related in that the path type 212 suggests which kinds of adjustments to the route 202 are applicable and/or available to a user. The adjustment 202 to the route 208 may be, for example, an alignment, a vertical adjustment, a horizontal adjustment, a curvature, and the like, as well as any combination of these. It will be understood that a wide variety of adjustments 202 may be applied to a route 208, and that all such adjustments are intended to fall within the scope of this disclosure.

The design rule 204 may be any constraint or rule that limits, constraints, dictates, or otherwise controls adjustments 202 in predetermined ways. In general, design rules may be absolute or relative, and design rules may dictate placement, shape, or other features of a particular element of a route or they may establish relationships among numerous different elements and/or the terrain or other path planning context. The design rules 204 in a particular design environment depend upon what the route 208 represents. For example and without limitation, when the route 208 represents a roadway the design rule 204 may be a maximum grade, a maximum pitch, a minimum turn radius, or and any all other suitable limitations. Certain constraints 204 may in turn depend upon other constraints 204. For example, where a roadway is being designed for travel at a certain speed, the speed may affect curvature or grade. The design rule 204 may additionally or alternatively be a maximum estimated cost. The design rule 204 may relate to a curvature ratio, a curvature length, a straight length, a transition length, a grade, and the like. It will be understood that a wide variety of design rules 204 may be applied to an adjustment 202 when determining whether a particular adjustment should be accepted, rejected, or modified. As used herein, the term “design rule” refers to any such constraint, which may be expressed as a rule, an equation, an algorithm, a lookup or other reference to external data, or any other constraint or function that can be expressed in computer code, as well as any combination of these.

FIG. 3 depicts a flow chart of a process 300 for interactive path planning that may be implemented on the system 100 described above. It will be understood that a wide variety of embodiments of the process 300 are possible and all such embodiments are intended to fall within the scope of the present disclosure.

The process 300 may begin 302 with receiving a manual route adjustment as shown in step 304. The adjustment, which may be received for example through the user interface described above, may include lateral and/or vertical movements of a waypoint or segment of a route; addition/removal of an element along a route; addition/removal of a waypoint or segment of a route; modification to a characteristic of a route, segment, waypoint, or element; and so on. Typically, user-initiated adjustments would be affected using a route alignment—the straight-line representation of a path—and any curvilinear transitions between intersecting line segments. However, it will be understood that other display models may be used, such as models based upon true route geometry or the like.

After receiving an adjustment, the process 300 may proceed to validate the adjustment as shown in step 308. This validation may evaluate the adjustment in light of design rules or any other suitable factors. If the adjustment violates any of the constraints then processing flow may halt, and the path may be maintained in its pre-alteration state. An error message, information message, or the like may be transmitted to a user, such as to alert the user of the rejected modification and/or to provide information concerning the nature of the validation error that resulted in the rejection. In one aspect, the validation process may correct a non-conforming adjustment to be a conforming adjustment. This may include, for example, addressing physical discontinuities in a vertical profile (e.g., a stair step vertical rise or excess grade in a railway path), expanding a radius of curvature, and so forth. In one aspect, validation is performed on a route alignment, however as noted above, other route models may be employed during this and other steps.

If the adjustment is validated in step 308, then the process may proceed to step 310 where the adjustment is applied to the route.

After applying the adjustment, the process may continue to step 312 where a cost is calculated for the route. Cost calculation may employ any suitable cost models, cost factors, and the like. For example, cost may include route length, route inclination, route curvature, construction materials (e.g., paving, barriers, curbs, gutters, etc.), material removal or addition costs, other physical infrastructure required to support the modified route (bridges, tunnels, etc.), intersection costs, and any other relevant factors, as well as any combination of these. A number of costing algorithms, formulae, and the like are known in the art and may be suitably employed to calculate costs with the process 300 described herein. In one aspect, the process may automatically select cost-optimized elements for a path. For example, tunnels, bridges, and the like may be automatically selected based upon relative cost, and inserted into a user-specified route alignment. In one aspect, optimization is performed on a route alignment and/or curvilinear transitions. However, it will be appreciated that other models may be employed for purposes of optimization.

As shown in step 314, the process 300 may then proceed to display route and cost information, such as within the user interface described above. The cost may be the cost calculated above in step 312. The route information may include a graphical display of a route, as modified and/or before the modifications. In one aspect, the process 300 may display a number of different costs, such as a cost before and after a modification, or two costs for two different modifications. Where multiple, inconsistent modifications are displayed, each modification/cost pair may be color-coded or otherwise displayed with a visual indication to provide user information concerning the relationship between particular costs and modifications. In one aspect, the cost is an approximate cost based upon a route alignment, possibly including curvilinear transitions. In another aspect, an alignment may be dynamically converted to a true geometric route (e.g., the model for physical construction) for purposes of cost calculation.

The display may be affected in a number of ways. For example, a server may calculate costs (using, e.g., a relatively high-powered or high-speed platform provided on a server-based system), including transformations, if any, required from the design representation of the route to a corresponding cost-calculation representation of the route. The calculated cost may be communicated from the server to a client which may, in turn, display the costs in a user interface. In another aspect, a stand-alone computer that effectively contains and/or provides the user interface 104, the application 114, and the database 112 may both calculate the cost 210 and display both the cost 210 and the route 208.

After displaying a cost according to a user-provided modification, the process 300 may end, as shown in step 318.

FIG. 4 depicts a flow chart of a process 400 for interactive path planning that may be implemented on the system 100 described hereinabove. It will be understood that a wide variety of embodiments of the process 400 are possible and all such embodiments are intended to fall within the scope of the present disclosure.

The process 400 may begin 402 with receiving a description of a route as shown in step 404. For example and without limitation, the application 114 may retrieve the description of the route 208 from the database 112.

After receiving the description, the process 300 may proceed to automatically adjust the route 208 as shown in step 408. Automatically adjusting the route 206 may include automatically creating the adjustment 202 and then applying the adjustment 202 to the route 208. The adjustment 202 may include adding various types of structures—such as bridges, tunnels, and the like—to or along the route 208. The adjustment 202 may, without limitation, include aligning segments, waypoints, structures, elements, and so forth. The adjustment 202 may, without limitation, be made in accordance with the design rules, which may include user-defined values, default values, and/or values that cannot be changed by the user. In one aspect, the automatic adjustment may repair discontinuities or rule violations in a user-created path, or otherwise address path defects. In another aspect, the automatic adjustment may affect an optimization of user-created path using, for example, any suitable optimization algorithms or the like known in the art. This may include, for example cost optimizations directed at minimizing the cost of the route, distance optimizations directed at minimizing the length of the route, or other optimizations according to, e.g., reducing vertical excursions, reducing turns, or reducing or optimizing any other objective or subjective criteria. Other optimizations may include selecting bridges, tunnels, and other elements on the basis of cost, and/or evaluating changes to the alignment to reduce or element the cost of such elements. In one aspect, cost optimizations may be calculated on a route alignment (optionally including curvilinear transitions). In another aspect, the process 400 may dynamically or otherwise transform the alignment to a true route geometry for performing optimization calculations. An error message, information message, or the like may be transmitted to a user, such as to alert the user to an automatic adjustment that is applied to the route 208.

In one aspect, adjustments may locally or globally optimize earthworks movements. For example, a local optimization may employ a number of costing rules that describe cost of moving as a function of particular machines and distance. In general, more expensive machinery such as a combination of an excavator and a dump truck can more cheaply move large amounts of fill over large distances. However, the initial cost of deploying this combination is high, and the combination may be highly cost-ineffective for moving a small amount of fill a few hundred meters. When automatically identifying adjustments, the process 400 may select a path (alignment, geometry, or the like as generally discussed above) that minimizes or otherwise optimizes the total cost associated with earth movement, including a consideration of fleet costs, distances, and so forth. As a further improvement, once a path has been optimized in this manner, the system may additionally seek to optimize deployment and use of equipment, such as by maximizing re-use of equipment and/or adjusting the path or earthwork movements to take full advantage of a particular fleet deployment. It will be appreciated that numerous additions and enhancements are possible consistent with the general notion of optimizing a path for earthworks movements and/or fleet deployment, and that all such variations are intended to fall within the scope of this disclosure.

In another aspect, optimization may apply a variety of different cost functions. For example, the system may calculate a proxy for environmental impact such as noise, carbon footprint, pollutants (e.g., due to additional driving distance), destruction or negative impact on natural resources, and so forth. A number of quantitative measures of environmental impact are known, and may be suitably employed in a costing or optimization function with the systems and methods described herein. It will be understood that in addition to various cost functions for environmental impact that might be employed, a particular path may be subject to regulatory or other constraints that dictate limitations on a design notwithstanding a calculated or optimized environmental impact. For example, a region may be designated as a protected ecological region that provides a habitat for an endangered species or a unique ecosystem designated for protection under local or national laws. While an environmental impact may be ecological, it may also be historical, social, or cultural. Thus for example, an historic site may be protected, or a cultural center of a populated area may be protected. The environmental constraint may prohibit path incursions within the protected area, or may impose additional remediation costs. For example, a route may be created across a cultural center; however relocation costs for the cultural center may be imposed as an environmental constraint. Similarly, environmental constraints might permit incursion of a route into a natural habitat, provided that an analogous ecosystem is reconstructed or cultivated in an appropriate, neighboring region. In general, the phrase ‘environmental constraint’ refers to any of these types of constraints on a path that are defined by subjective human rules rather than geophysical construction costs.

After automatically adjusting the route, the process 400 may calculate a new or revised cost of the route 208 as show in step 410, according to any of the cost calculation techniques described herein.

Having calculated the cost 210, the process 400 may display the route 208 and cost 210 as shown in step 412. The route 208 and cost 210 may be displayed in a user interface as generally described above with reference to FIG. 3.

After displaying a cost according to an automatic adjustment, the process 400 may end, as shown in step 414. Although not depicted, the process may also, or instead, repeat to perform another automatic or manual adjustment to the route. Other functions may also be provided in addition to those depicted, such as creating routes with minor violations, displaying minor violations, displaying alternative routes, and so forth.

It will be appreciated that numerous variations are possible for the processes described above. For example, a user may selectively activate or deactivate costing and optimization during a design process. Thus, for example, a user may complete an entire alignment for a route, and then seek to have the route optimized and costed. In subsequent revisions, a user may select between a mode in which adjustments are automatically and continuously applied to design revisions, and a mode in which only costs are calculated, thus permitting full user control over a design. Where computing resources are constrained, the process(es) may permit manual control over whether costing is performed on an alignment or a true route geometry, where alignment-based calculations are presumptively (but not necessarily) less computationally expensive. Other features noted above, such as automated selection and placement of bridges and the like may also be optionally activated and/or deactivated during various stages of an iterative design process under user control. All such variations as would be apparent to one of ordinary skill in the art and may be usefully combined with the interactive design methods and systems described herein are intended to fall within the scope of this disclosure.

Turning now to the user interface, FIG. 5 shows a user interface 500 for interactive path planning. The user interface 500 may include various visual representations of a path and/or a path planning context, including without limitation a plan view 502, a path 504, a cross-section indicator 508, a waypoint 510, a radius 512, a path summary 514, a cross-sectional view 518, a vertical path view 520, a terrain alteration 522, a total cost 524, and so on. The following description of various embodiments of a user interface is provided by way of examples only and not of limitation. It will be understood that a wide variety of visualization and user interface techniques are known in the art and may be suitable adapted for use with the systems and methods described herein.

The user interface 500 may enable a user to add, suggest, delete, or otherwise modify elements of the path (or the context for the path), and may indicate when automatic changes have been made to any of the foregoing. Visual cues such as color coding, shading, and the like along with suitable legends or text descriptions, may be provided for a user. In one aspect, these items can be customizable for user selection of color-coding, themes, or the like. The user interface 500 may enable a user to hide some elements (e.g. cross-section indicators) of the project while showing other kinds of elements (e.g. waypoints and radii). It will be understood that various embodiments of the user interface 500 are possible.

The plan view 502 may be an overhead view of terrain including a representation of the route 208 and related elements. The plan view 502 may include features that allow for horizontal scrolling, vertical scrolling, zooming in and out, and so on. The plan view 502 may display the terrain in relief so as to provide visual cues as to the relative height of the terrain at any given point. The plan view 502 may depict any and all suitable elements of the route 208. It will be understood that various embodiments of the plan view are possible.

In general, the path 504 is a visual representation of the route 208, and may include any of the corresponding features and/or aspects described herein. It will be understood that many possible visual representations for the path 504 are possible, including representations that provide location information (e.g., in plan or profile views, or some combination of these) as well as information concerning the elements of the path. For example, the display may include callouts to describe the elements of various sections of the path, or may employ color-coding, various symbols (along with a legend, as appropriate), graphic depiction of various features, and so forth.

The cross-section indicator 508 may show the position of a cross section along the path 504. Moreover, the cross-section indicator 508 may show the cross section's direction of cut and/or orientation of cut. It will be understood that the particular depictions of the cross-section indicator 508 are provided for the purpose of illustration and not limitation. Multiple cross-section indicators 508 may be provided, each having its own position, direction of cut, orientation of cut, and so on. Upon detecting a problem or irregularity with a route 208, the system 100 may generate and display a cross-section indicator 508 that highlights the problem and/or a proposed solution to the problem.

The waypoint 510 may show an intersection point or other point along the route 208 of the path 504. Any and all number of waypoints 510 may be included with the path 504.

The radius 512 may be an indicator of a curvature in the path 504. Any and all number of radiuses 512 may be included with the path 504.

The path summary 514 may be a user interface element that shows information relating to particular elements in the path 504 as well as aggregate information relating to the path 504 as a whole, along with details concerning various path elements or groups of path elements. As depicted, the path summary 514 may include a column containing a brief description of any and all elements, kinds of element, and/or group of elements in the path 504; a column containing a quantifier for any and all of these items, elements, and/or or groups of elements; a cost column containing a cost for any and all of these items, elements, and/or groups of elements; the total cost 524; and so on. Any and all values provided by the path summary 514 may be updated substantially in real time. This may occur, for example, when the path 504 is displayed or updated, when assumptions are set or changed, when any and all other information that relates to the values changes, and so on.

The total cost 524 may show the sum total of the costs in the cost column.

Any and all of the costs, including the cost for each item and the total cost 524, may be an abstract number (that is, measured in “units of cost”) that can be converted into a real-world cost at a later time according to, e.g., relevant currencies and costs of labor, materials, and the like in a particular location or group of locations. This abstract number may allow a designer to see the relative changes in cost as the adjustments 202 are applied to the route 208. Alternatively or additionally, the cost for each item may be an actual cash value in a real-world currency (such as and without limitation US Dollars, Euros, British Pounds, Chinese Yuan, and the like). In this latter case, costs may nonetheless be varied according to geographical location, which may in many instances have a significant impact on various building costs. In any case, the cost represents a calculated estimate of the actual costs of constructing the element that is associated with the cost. The cost may be based upon one or more assumptions, actual costs, historical costs, projected costs, estimated costs, bids, projections, or the like.

The cross-sectional view 518 may be a user interface element that shows a cross-section of the path 504 and the terrain. In the present depiction, which will be understood to be provided for the purpose of illustration and not limitation, a horizontal line that is centered at (0,0) may represent the path 504, a longer horizontal line that is centered at (0, 20) may represent terrain as it currently exists, and diagonal lines connecting the endpoints of the two horizontal lines may represent a cut into the terrain that would be made if the path 504 were built. The path 504 and the cut may be parts of the route 208. Generally, elements of the route 208 may be depicted in the cross-sectional view 518. The cross-sectional view may display additional information that relates to the cross-section of the path 504. This additional information may, without limitation, include bearing, grade, radius, elevation of the path relative to the existing terrain, elevation of the path above sea level, any and all combinations of the foregoing, and so on. The cross-sectional view 518 may depict any suitable elements of the route 208. The cross-sectional view 518 may include color-coded elements allowing a plurality of paths and/or elements to be simultaneously and distinctly shown. For example and without limitation, some color-coded elements may distinctly show a current path while other color-coded elements may distinctly show a suggested or alternate path. It will be understood that many embodiments of the cross-sectional view 518 are possible.

The vertical path view 520 may be a user interface element that shows a side-on depiction of the path 504 and the terrain along the centerline of the path 504. Terrain under the path 504 may be depicted as a darker color. Terrain to be cut away or filled according to the route 208 may be depicted as the terrain alteration 522. Sky above the terrain may be depicted as a lighter color. The vertical path view 520 may include the cross-section indicator 508. The vertical path view 520 may depict any and all suitable elements of the route 208. The vertical path view 520 may include color-coded elements allowing a plurality of paths and/or elements to be simultaneously and distinctly shown. It will be understood that various side-on depictions of the path 504 may be possible.

The terrain alteration 522 may depict portions of the terrain are cut away or filled according to the route 208. It will be understood that many a variety of such depictions are possible.

The user interface 500 may enable a user to add, delete, modify, and/or move any and all of the elements of the interface 500, including without limitation those elements of the interface 500 that correspond to elements of the route 208. For example, the user interface 500 may receive manual adjustment to elements and/or curves along the route 208. The user interface 500 may display, substantially in real time, any and all modifications to the elements of the interface 500. It will be understood that these modifications may be due to user input and/or an automatic step in a process. Such an automatic step may without limitation be the automatic step 408 in the process 400 described hereinabove with reference to FIG. 4. The user interface 500 may display, substantially in real time, one or more updated costs reflecting the modifications. The user interface 500 may enable the system 100 to capture and encode the user's revisions to the elements, which encoding may be stored in a database using, e.g., the data structure 200 described above.

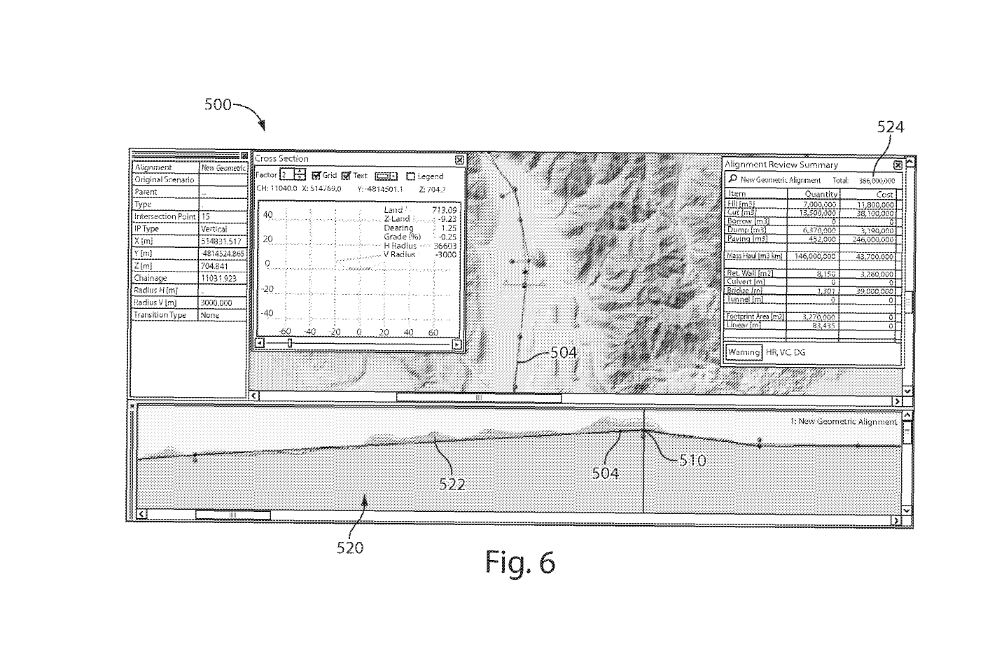

FIG. 6 shows a user interface 500 for interactive path planning. In general, FIG. 6 shows the addition of a waypoint to a path. The user interface 500 may include for example the vertical path view 520, the terrain alteration 522, the total cost 524, and the path 504 as generally described above, along with an additional waypoint 510.

As depicted, the additional waypoint 510 changes the path's profile in the vertical path view 520. It can also be seen that the changes to the path's profile reduce the terrain alterations required by the project, resulting in a corresponding change (reduction) in the cost. The interface also shows which components of the cost contributed to the cost reduction. The change in the path's profile may conform to one or more standards or design rules as generally described above. For example, such a standard may specify a maximum vertical curvature of the path 504.

The additional waypoint 510 may be added automatically, such as according to any of the methods described above. Additionally, changes to the additional waypoint 510, the path's profile, the terrain alteration's area, and the total cost 524 may be displayed substantially in real time.

A comparison of FIGS. 5 and 6 generally illustrate a user interface displaying modifications to a route along with corresponding changes in cost. It will be appreciated that this particular example in no way limits the scope of this disclosure.

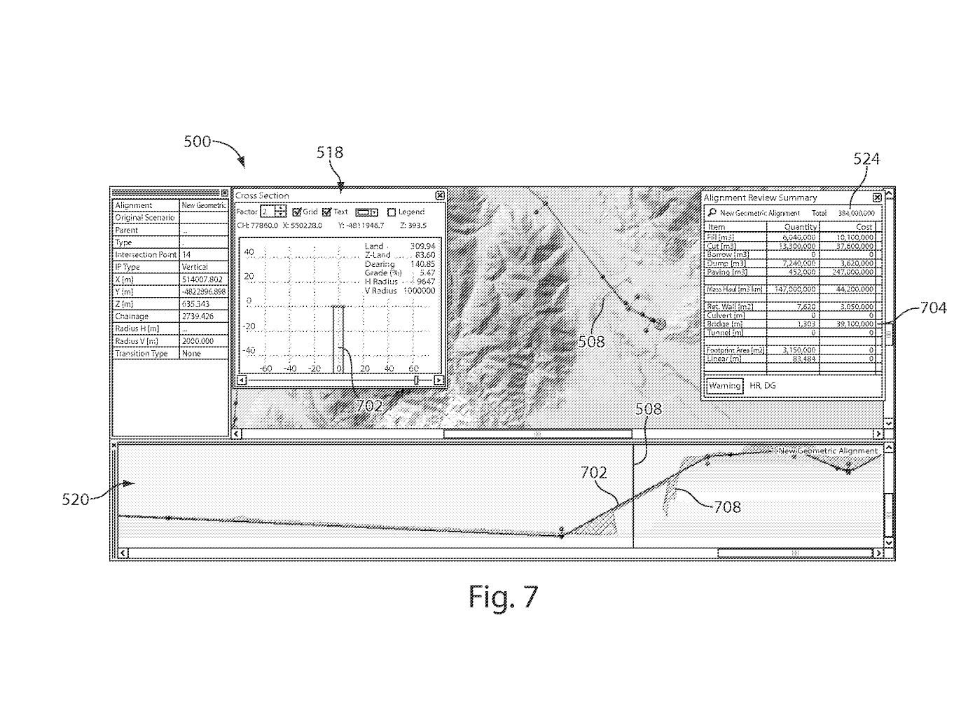

FIG. 7 shows a user interface 500 for interactive path planning. In this example, the user interface 500 depicts a path planning environment including a bridge 702, a bridge cost 704, the total cost 524, the cross-section indicator 508, the cross-sectional view 518, the vertical path view 520, a retaining wall 708, and so on. In general, the figure depicts an addition of a bridge 702 to a path, along with substantially real-time updates to path elements and the path construction costs.

The bridge 702 is depicted in the cross-sectional view 518 as two vertical lines joined by a horizontal line. As depicted, the horizontal line represents the path's surface. For example, the horizontal line may represent a roadway, rail bed, or the like. The vertical lines represent the height of the path's surface above the terrain.

The bridge 702 is also depicted in the vertical path view 520, along with a visual indication of the area between the bridge and the underlying terrain. The bridge 702 may be manually inserted by a user, or automatically inserted into the path during a cost optimization, length optimization, or other computer-assisted path planning step, with associated costs updated in substantially in real time.

As generally described above, the system may automatically select a supporting structure such as the retaining wall 708, which may reduce cost indirectly such as by reducing a span required for the bridge 702. The supporting structure may be added to the path, and displayed along with corresponding cost information in the user interface. It will be appreciated that the addition of a retaining wall is an example only, and that numerous structures, earthworks movements, and the like may be automatically added to the design where an optimization calculation identifies a potential cost savings, and that all such automatic modifications apparent to one of ordinary skill in the art are intended to fall within the scope of this disclosure.

The total cost 524 may be displayed in a window or other region of the user interface, and may display components of cost with any suitable degree of granularity. For example, the cost of a new geometric alignment may include quantity and unit costs for various components of path construction such as fill, cut, borrow, dump, pave, and haul, as well as elements within the path such as retaining walls, culverts, bridges, tunnels, and the like. The system 100 may calculate and display the bridge cost 702 and the total cost 524 for a revised path substantially in real time. It will be understood that numerous techniques for displaying costs may be employed. For example, costs may be displayed in a spreadsheet or tabular form as side-by-side comparisons of costs before and after a path change, or costs may be displayed as relative or absolute change relative to an original scenario, or the interface may employ some combination of these. Further, while depicted as a window within a user interface, cost information may be displayed in a variety of ways such as within pop-up window, within a frame or other pre-determined region of a window, within a border of a window along with other status information, or in any other suitable manner. In one aspect, cost information may be displayed in a status bar at the bottom of a user interface window, with detailed cost information available by pointing and clicking with a mouse or other input device within the corresponding region of the interface. All such variations are intended to fall within the scope of this disclosure.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A method comprising:
displaying a route and a cost of constructing the route in an interactive route design interface;
receiving an adjustment to the route;
calculating an updated cost of the route with the adjustment; and
displaying the updated cost in the interactive route design interface in substantially real time.

2. The method of claim 1 wherein receiving the adjustment to the route includes receiving an adjustment to an alignment that defines the route as a series of straight lines joined at one or more intersecting points.

3. The method of claim 2 further comprising adding a transition curve to at least one of the one or more intersecting points to form a curvilinear path between two adjacent ones of the series of straight lines.

4. The method of claim 3 further comprising calculating the updated cost based upon the curvilinear path.

5. The method of claim 1 wherein the route is one or more of a railway path and a roadway path.

6. The method of claim 1 wherein the route includes at least one of a printed circuit board trace path, a canal path, a subway path, a utility path, a duct path, a conveyor belt path, and a pipe path.

7. The method of claim 1 wherein the adjustment to the route includes one or more of a vertical adjustment and a horizontal adjustment.

8. The method of claim 1 further comprising automatically selecting an element of the route according to cost in response to the adjustment.

9. The method of claim 8 wherein the element includes one or more of a bridge, a tunnel, an earthworks, a bench, a retaining wall, and a stepped batter slope.

10. The method of claim 1 further comprising automatically adjusting an element of the route according to cost in response to the adjustment.

11. The method of claim 10 wherein the element includes one or more of a bridge, a tunnel, an earthworks, a bench, a retaining wall, and a side slope.

12. The method of claim 1 further comprising testing the route against a design rule in response to the adjustment.

13. The method of claim 12 wherein the design rule includes a limitation on one or more of a curvature radius, curvature length, straight length, transition length, and a grade.

14. The method of claim 12 further comprising either stopping the adjustment or rejecting the adjustment when the adjustment violates the design rule.

15. The method of claim 12 further comprising automatically revising the adjustment to conform to the design rule when the adjustment violates the design rule.

16. The method of claim 1 further comprising testing the route against an environmental constraint in response to the adjustment.

17. The method of claim 16 wherein the environmental constraint relates to a region of social, historical, or cultural significance.

18. The method of claim 16 wherein the environmental constraint relates to a protected ecological region.

19. The method of claim 16 wherein the environmental constraint prevents an incursion of the route into a region.

20. The method of claim 16 wherein the environmental constraint imposes remediation costs for an incursion of the route into a region.

21. The method of claim 1 wherein the interactive route design interface includes a web-based interface and wherein calculating a cost includes calculating the cost at a remote server and transmitting the cost to a client that provides the web-based interface.

22. The method of claim 1 wherein all of the steps are performed by a client-based application.

23. The method of claim 1 wherein all of the steps are performed on a stand-alone computer system.

24. A method comprising:
receiving a description of a route;
automatically optimizing the route according to a cost;
displaying the route and the cost;
receiving a manual adjustment to the route;
calculating an updated cost of the route with the manual adjustment in substantially real time; and
displaying an updated cost in substantially real time.

25. The method of claim 24 wherein displaying the route includes rendering the route within a three-dimensional terrain model.

26. The method of claim 24 wherein displaying the route includes rendering the route in a plan view and a profile view.

27. The method of claim 24 further comprising checking the manual adjustment against one or more design rules, and incorporating the manual adjustment into the route only when the manual adjustment conforms to the one or more design rules.

28. A method comprising:
displaying a three-dimensional model of a terrain;
receiving a description of a route including a series of straight elements joined by a plurality of intersection points within the three-dimensional model;
automatically inserting one or more curves that conform to a design standard at each one of the plurality of intersection points;
automatically inserting one or more elements along the route, the one or more elements including at least one of a bridge, a tunnel, a retaining wall, and a stepped batter slope, and each one of the one or more elements selected according to a cost of the element as constructed in the terrain;
calculating a cost of the route, including the one or more curves and the one or more elements in substantially real time, and
displaying the cost.

29. The method of claim 28 wherein the one or more curves include at least one of a circular segment and a spiral segment.

30. The method of claim 28 further comprising displaying the description of the route on the three-dimensional model.

31. The method of claim 30 further comprising displaying the description of the route in one or more of a plan view and a profile view.
